(19) United States
(12) Patent Application Publication
(10) Pub. No.: US 2008/0190529 A1
(43) Pub. Date: Aug. 14, 2008

(54) Resilient caster

(76) Inventors: John Dueker, Ballwin, MO (US); Daniel Ranson, St. Louis, MO (US)

Correspondence Address: Mark Manley, University of Central Missouri, Dockery Building Room 102, Warrensburg, MO, 64093, US

(21) Appl. No.: 11/703,856

(22) Filed: Feb. 8, 2007

(51) Int. Cl. B60B 9/00

(52) U.S. Cl. 152/97

(57) ABSTRACT

A wheel assembly, including a rim and a central hub assembly, having a plurality of spokes threaded to a central hub. Each of the spokes movable under spring load within a tangential slots provided on the rim. A spring surrounding each spoke, with a first end of the spring engaging the central hub. When the wheel assembly is rolling and encounters a force caused by a bump and the rim deflects radially, the rim moves radially, causing the slots to move radially and tangentially along the spokes while the springs absorb the impact caused by the bump.

### RELATED APPLICATIONS

None

### BACKGROUND OF THE INVENTION

Wheeled transportation has existed for a long time. A common problem in wheeled transportation is caused by bumps in the pathway of vehicles. For example, when patients in a medical facility are transport on carts, those carts typically have solid wheels that absorb little or none of the impact cause as the cart travels over transitions in the floor such as might occur at an elevator for example. Patients who may be critically ill, suffer as their bodies must absorb the jolt of the impact as a wheel travels over a transition. Solid wheels provided in the prior art are noisy because they do not absorb shock. Small hand carts typically do not have any shock absorbing capability so as a hand cart with prior art solid wheel rolls down a hall even very small objects and irregularities will cause the hand cart to rattle and jar creating noise, vibrating loads and setting up potential ergonomic problems for workers who frequently move hand carts.

U.S. Pat. No. 4,782,875 provides one solution to attempt to smooth the ride of a wheeled vehicle on a surface. A suspension arrangement is built in to a spoked wheel hub. The arrangement mounts each spoke on a leaf spring that allows the wheel to deflect as the wheel moves over an obstacle. The hub and wheel provides a potential solution but the complexity of this arrangement is not likely to be cost effective and may not work for small diameter wheels such as might be found inside a hospital or on various hand operated carts. Further, the design includes specialty leaf springs that would also be costly.

U.S. Pat. No. 1,890,442 discloses a spring wheel having telescoping spokes. The patent does allow for some radial and tangential motion of the wheel relative to the hub but the telescoping spokes are allowed to move relative to the hub requiring that the spokes be provided in pairs and that the spokes are not coplanar requiring a very deep wheel because the spokes must be staked. The patent also allows the wheel to ‘bottom out’ on the springs which will make an uncomfortable ride and quickly lead to spring failure. It is also felt that the wheel made according to this patent would produce a sudden ‘clunk’ each time the spoke passed through the upright position, this is caused because the spoke pairs will suddenly shift from a trailing position on the guide ‘F’ to a lead position as shown in FIG. 2 of the patent.

As can be seen there is a need for a simple and inexpensive shock absorbing wheel.

### SUMMARY OF THE INVENTION

According to the invention, a wheel assembly is provided, including a rim and a central hub assembly, having a plurality of spokes threaded to the central hub. A plurality of tangential slots are provided on the rim and the spoke can move radially and tangentially within the slot. An resilient member such as a spring is provided for each spoke, with a first end of the spring engaging the wheel rim or wheel and a second end of the spring engaging the central hub. When the wheel assembly is rolling and encounters a bump and the rim deflects radially relative to the hub assembly, the spokes can move radially and tangentially along the slots while the springs absorb the impact caused by the bump.

In another aspect of the invention a wheel assembly is provided that uses internal springs to absorb shock.

These and other advantages of the present invention will become apparent from the detailed description of the invention.

### BRIEF DESCRIPTION OF THE DRAWINGS

FIG. 1 shows a side view of an embodiment of the invention;

FIG. 2 shows a sectional view taken along line A-A in FIG. 1;

FIG. 3 shows an exploded view of the device; and

FIG. 4 shows a drawing of the present invention hitting an obstacle.

### DETAILED DESCRIPTION OF THE DEVICE

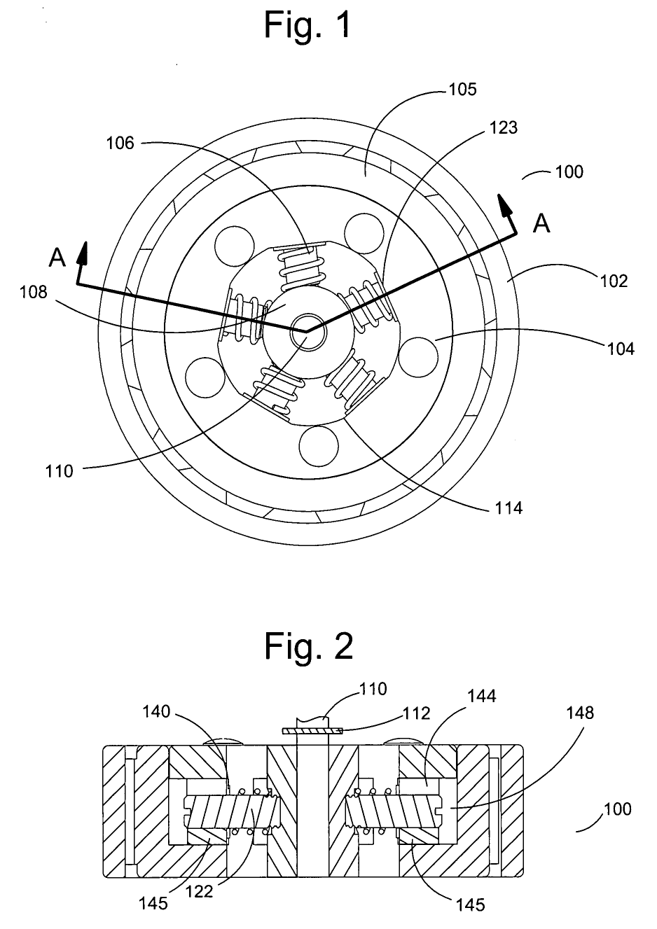

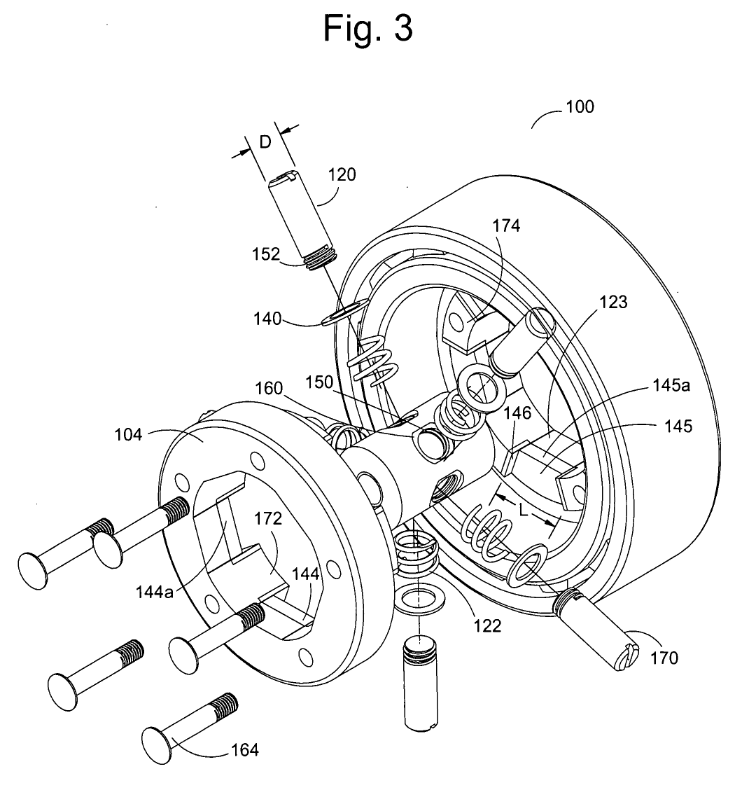

FIGS. 1 and 2 show views of the wheel 100. The wheel 100 includes an outer diameter portion such as tire 102 that might be solid rubber or nylon for example, an inner rim portion 104, an outer rim portion 105 also make up outer diameter portions, spoke assemblies 106 and a hub 108. The hub 108 includes an axle 110 to mount the wheel 100 to a vehicle 112 such as a wheel chair, 2 wheeled dolly, or patient gurney for example. Holes 114 allow for the passage of bolts (164), see FIG. 3, to hold the inner rim portion 104 to the outer rim portion 105 forming the rim 104/105. Once bolted together the rim 104/105 is essentially a one piece continuous rim.

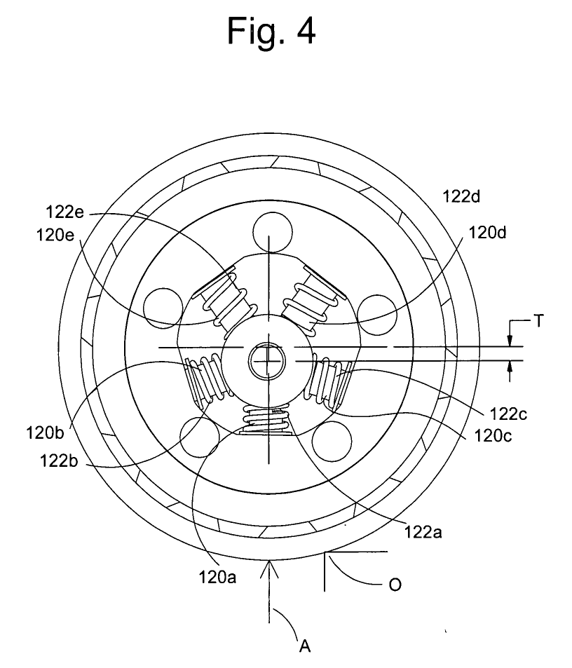

As shown, the wheel 100 includes 5 spoke assemblies 106, each spoke assembly 106 includes a solid radially extending one piece member such as central spoke 120 and an elastomeric or resilient member such as spring 122 surrounding the spoke 120. The wheel 100 is designed so that if the wheel 100 encounters an obstacle such as a threshold in a building, that some of the spoke assemblies 106 will compress to absorb a portion of the impact caused by the obstacle (See FIG. 4).

FIG. 2 shows a cross sectional view of the wheel 100 along line A-A in FIG. 1. The cross section shows that the hub 108 is normally centered in the wheel 100 and that each coplanar spoke 120 includes a washer portion 140 that contains the springs 122 and that sits on a flat 123 on the inner diameter 114 of the rim 104. The washers 140 provides a flat surface for the springs 122 to bear against while the spoke 120 can move relative to the washer 140. When the inner rim portion 104 is bolted to the outer rim portion 105 a slot 148 in FIG. 2 is formed. Openings such as slots 148 provide clearance for the spoke 120 to travel radially and tangentially relative to said wheel assembly 100. FIG. 2 shows that the axle 110 can extend beyond the wheel 100 to attach to a vehicle 112.

FIG. 3 provides an exploded view of the wheel 100. The spokes 120 include washers 140, the spokes 120 have a diameter indicated by ‘D’. The step 145 has a length L that is the same as the length of step 144 and that is larger than ‘D’. When bolted together steps 144 and 145 form slot 148. The width of the slot 148 is also greater than ‘D’ such that the spoke 120 can move within the slot 148. The slots 144 and 145 can be lined with a cushion material 144a and 145a that is press fit into the slots 144 and 145 and provides a cushioned end 146 for the spokes 120 to impact at maximum travel. Alternatively the rim 104/105 or spoke could have no cushion or be made of a material such as delrin or hard rubber that would have some cushioning and no insert would be needed.

FIG. 3 shows that the hub 108 can include threaded holes 150. The spokes 120 also include a threaded end 152 such that the springs 122 can be placed over the spokes 120 and the springs 122 can be slightly compressed to a preload at assembly. Each hole 150 includes a step 160 that provides a flat surface for the spring 122 to press against in compression. A similar flat surface 123 can be provided for the washer 140 to sit on the inner diameter 114 of the rims 104 and 105 but that flat surface 123 is elongated to allow for tangential movement of the spoke 120 in the slot 148. The hub 108 and spokes 120 are shown threaded together, alternatively the hub 108 and spokes 120 could be formed as a single piece such as by casting or molding.

To assemble the wheel 100, a spring 122 is placed over a spoke 120 and that spoke 120 is threaded into the hub 108. After the five spokes 120 are threaded to the hub 108, the hub 108 with spokes 120 attached is placed into the outer rim 105 with the washers 140 resting on the inner diameter of the outer rim 105. Then the inner rim 104 is aligned and bolted to the outer rim 105 using bolts 164. Each spoke 120 includes a slotted head portion 170 that can move tangentially and radially within the wheel 100 within the slot 148 created by raised portions 172 on the inner rim 104 and raised portions 174 on the outer rim 105. The hub 108 floats on the springs 122 and is normally centered in the wheel assembly 100 until a load is applied to the axle 110. The length L of the slot 148 determines the maximum travel of the spoke 120 that is traveling in the slot 148. A spoke 120 will normally float and not contact the end 146 of slot 148 but under loading in excess of a design limit amount the spoke 120 will come in contact with a padded end 146 located at either end of the slot 148 and separated by the distance L. The padded end 146 can be an elastomeric material such as phenolic or rubber and will cushion the impact as the spoke 120 comes in contact with the slot 148 wall. The travel of the spoke 120 under load is thus limited in the tangential direction and the spoke 120 will not ‘bottom out’ in the radial direction against the rim. There continues to be a gap (at number 148 in FIG. 3) between the head of the spoke 170 and the rim 105.

FIG. 4 shows what happens when the wheel 100 encounters an obstacle ‘o’ as it is rolling over a surface. The impact of the obstacle ‘o’ will cause the lowest spring 122a to compress while the upper springs 122d and 122e expand. It can be seen that the lowest spring 122a will compress while the spoke 120a moves in a radial direction downward as indicated by arrow A. It will also be seen that the springs 122b and c will also tend to compress but not as much as spring 122a. It can also be seen that the head portion 170 of the spokes 120b and c will need to move tangentially relative to the rim 104 as well as radially. “T” indicates the amount of displacement of the center of the rim 104/105 caused by the load when the wheel 100 impacts the obstacle ‘o’. Each spoke 120 is fixed relative to the hub 108 and so the movement caused by the upward motion ‘A’ of the rim 104/105 must be compensated at each spoke 120. The slot 148 and washer 140 arrangement allow the spokes 120 to move tangentially while also moving radially. After encountering an obstacle the wheel assembly 100 will then return to its normal position with the rim nearly centered as shown in FIG. 1. By allowing both radial and tangential motion, impact force can be resolved by mechanism in a much superior manner than previous wheels. Established geometric triangles are maintained in this design producing a smoother ride that will preserve the structural integrity of the device.

As can also be seen in FIG. 4 the spokes 120b and c are fully against their corresponding slots 148 before the head portion 170 of the bottom spoke 120a can impact the rim 104, 105. If the wheel 100 hits a large enough obstacle the spokes 120b and c will bottom out on padded end 146 at the end of the slots 148

Spring rate of the springs 122 will be determined by design and the application. The springs 122 can be a constant rate spring or the springs 122 can be proportional springs having a variable rate of compression. The springs 122 will typically have a preload.

Although the present invention has been described with reference to particular embodiments, workers skilled in the art will recognize that changes may be made in form and detail without departing from the spirit and scope of the invention.

1. A wheel assembly including;
a rim, a central hub assembly having a plurality of spokes,
a plurality of tangential openings provided on said rim,
a plurality of resilient members supporting said hub, such that when said rim deflects radially relative to said wheel assembly, said spokes move radially and tangentially along said openings.

2. The wheel assembly of claim 1, wherein said openings are slots and each slot length in the rim controls the amount of deflection travel of the rim relative to the hub.

3. The wheel assembly of claim 1 wherein said resilient members are coil springs surrounding and co-axial with said spokes.

4. The wheel assembly of claim 2 wherein said slot includes a cushioning insert such that as said wheel encounters an obstacle at least one of said spokes moves tangentially toward a portion of said cushioning insert.

5. The wheel assembly of claim 4 wherein tangential motion of said spokes toward said cushioning insert controls the maximum deflection of the rim relative to the hub

6. A wheel assembly including;
a central hub assembly having a plurality of spokes,
said wheel having an outer diameter portion surrounding said hub,
a plurality of tangential openings provided on said outer diameter portion,
a plurality of springs supporting said hub, such that when said outer diameter portion deflects radially relative to said hub, said spokes move radially and tangentially along said openings.

7. The wheel assembly of claim 6, wherein said openings are slots and each slot length in the outer diameter portion controls the amount of deflection travel of the outer diameter portion relative to the hub.

8. The wheel assembly of claim 7 wherein said resilient members are springs co-axial with said spokes and said spokes are co-planar.

9. The wheel assembly of claim 7 wherein said slot includes an end portion such that as said wheel encounters an obstacle at least one of said spokes moves tangentially toward said end portion.

10. The wheel assembly of claim 9 wherein the tangential motion of said spokes toward said end portion of said slot controls the maximum deflection of the outer diameter portion relative to the hub.

11. The wheel assembly of claim 10 wherein said end portion includes an elastomeric cushion to resiliently control the motion of at least one of said spokes near the end of the slot.

12. A wheel assembly including;
a central hub assembly having a plurality of radially extending members supporting the hub within a rim,
said rim surrounding said hub,
a plurality of openings provided on said rim,
a plurality of elastomeric members supporting said hub, such that when said rim deflects radially relative to said hub, said radial extending members move radially and tangentially along said openings.

13. The wheel assembly of claim 12, wherein at least one of said openings in the rim controls the amount of deflection travel of the rim relative to the hub.

14. The wheel assembly of claim 13 wherein said resilient members are springs co-axial with said radial extending members.

15. The wheel assembly of claim 14 wherein said at least one opening includes an end portion such that as said wheel assembly encounters an force at least one of said radial extending members moves tangentially toward said end portion.

16. The wheel assembly of claim 15 wherein the tangential motion of said at least one of said radial extending members toward said end portion controls the maximum radial deflection of the rim relative to the hub.

17. The wheel assembly of claim 16 wherein said radial extending member is a spoke fixed to said hub.
